(19) United States
(12) Patent Application Publication
(10) Pub. No.: US 2012/0276512 A1
(43) Pub. Date: Nov. 1, 2012

(54) Computer Implemented Skill Improvement Systems And Methods of Using Computer Implemented Skill Improvement Systems

(76) Inventors: Stephen Thomas Johnston, San Diego, CA (US); Paul Monette, West Henrietta, NY (US)

(21) Appl. No.: 13/279,211

(22) Filed: Oct. 21, 2011

Related U.S. Application Data
(60) Provisional application No. 61/455,447, filed on Oct. 21, 2010.

(51) Int. Cl. G09B 5/00

(52) U.S. Cl. 434/309

(57) ABSTRACT

Embodiments of the claimed subject matter relate to devices, systems and methods using those devices used in improving the skill of one or more users, and more particularly, devices that can be used to view, record and playback activities which can be reviewed later and used for training feedback. One example includes positioning one or more audio or visual or audio visual recording devices having an unobstructed view of a performance area, recording video and/or audio of the one or more participants within the performance area over a period of time, processing the video and/or audio recordings and storing said recordings as a digital file format to one or more digital storage devices connected to a computer network, and allowing the stored digital files to be played and viewed over the computer network.

### CROSS-REFERENCES TO RELATED PATENT APPLICATIONS

The subject matter described in the present application is related to that described in the U.S. Patent Application No. 61/455,447 to Johnston and Monette filed Oct. 21, 2010, now pending, which is incorporated by reference herein in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD

Embodiments of the claimed subject matter relate to computer implemented devices, systems and methods using those devices and systems in training individuals and groups of individuals, and more particularly in training individuals and groups of individuals seeking to improve their respective skills.

### BACKGROUND

There are many areas or fields of endeavor where participants or teams seek to improve their skills. Some examples might be in sports, public speaking, presenting of information, performance arts, physical hobbies, or other physical activities. The claimed subject matter presents methods and systems which allow one or more individuals the ability to improve their skills in any field by using networked video and audio with feedback readily available via the internet.

In any endeavor which can be improved by the skillful repetition of an action or speech, it is well understood and generally accepted that participants or teams watching video of themselves performing these actions have the opportunity to review their mistakes by watching and listening to their performance on recorded video and then repeating the action or speech avoiding mistakes. Similarly, participants or teams watching video of themselves performing these actions have the opportunity to review their success by watching and listening to their performance on recorded video and then repeating the action or speech that led to the success.

Current methods and processes for this type of skill improvement rely heavily on different person(s) or system(s) to record the video and audio of the endeavor and then review with the person attempting the endeavor. Other methods for this type of skill improvement rely on the person attempting the endeavor to record their own video or audio, and then review it separately on a recording device or display.

The problem is that persons must have recording devices and media available to record the video and audio, and then transfer that to another system for review and playback. One example of this is having a parent or friend in the spectator seats at a sports facility record a sports competition on a digital camcorder, and then transfer that video to a television or computer that the sports participant can view. A second example is a person setting a digital recorder to record themselves giving a speech, and then transferring the video and audio to a television or computer to review their talking patterns, posture, and body gestures. A third example is a performing arts team rehearsing a theatrical play and having a crew-member record the rehearsal for later review. Each of these examples demonstrate a person or team seeking to improve their skills using video in a non-automated method where the video and audio need to be transferred manually to another device for review.

Another problem is that current systems which allow video and audio review are isolated systems that are not easily accessed by the participant or participants. One such system currently in use is comprised of a video recorder connected to a television or monitor, which can only be reviewed by the participant when at the facility with the video playback machine or by taking the recorded media with them. This system does not allow ready access by the participant from any location, and it does not allow ready access by other team members or by the coach, unless each person makes a copy of the recording media.

Another such system currently in use is a digital video recorder which contains a playback screen or can be readily connected to a television or larger screen, such as a camcorder or handheld personal digital video recorder. These are convenient in that the recorder and playback system are combined into a single machine, but copying the digital recording is still a manual process and cannot be readily shared with others, such as teammates or distant relatives, except by time-consuming copying of the digital recording. Posting the video onto a social networking website is also a manual process, and the participants cannot readily find the video unless the person uploading the video makes it available to each person.

Another such system is a security surveillance system that provides multiple and synchronized digital recordings and storage of digital video files, but each file must be offloaded from the storage device individually using an internet browser. There is no automatic method to transfer many files available on security surveillance systems using computer programs that automatically fetch the digital files or automatically send the digital files.

Another problem with systems currently in use is that those systems only provide a single video angle which must be manually positioned or manually operated by a person. Getting multiple video requires two recording systems, and the recorded video from the two systems cannot be easily synchronized or reviewed at the same time. While some systems like this are available to high-end professional sports teams, those systems still rely on manual operation of the recording devices.

Another problem with current solutions is that the recording device is normally located in a position which is poor for reviewing the performance of the participant or team. Recording devices operated by friends or parents in the seating area of a sports field offer a poor angle to view the participant positions on the sports playing area. The field of view is often blocked by nets, glass, pillars, or other obstructions. Most sports coaches and players agree that an overhead view is preferable for reviewing teammates positions and the participant's execution of a particular play.

Another problem is that the video of a participant or team only follows a particular player or an object and the video perspective changes frequently. In this case, the person or team seeking to improve their skills cannot readily review their performance since the video recording may not contain the location or time of interest to the participant or team member seeking to review their performance.

To the best of the inventors' knowledge, the present embodiments of such improved devices and methods have not been provided in the art. The present application provides some of such improved methods and systems that are useful in the training of individuals as well as groups of individuals which aid in the improving their respective skills.

### SUMMARY

This inventive subject matter is briefly summarized as an automatic recording system for multiple video and audio that makes the digital recordings readily available on the internet to the participants, coaches, and teams seeking to review their performance and improve their skills.

Embodiments of the claimed subject matter include novel coordination and integration of several technologies and available products which are applied in novel ways. Embodiments use video recording devices and microphones in fixed positions mounted at a sports facility, performance hall, or other venues. Several embodiments automatically convert the recorded video and audio into a digital format and automatically transmit the digital information to a computer network such as the internet. The digital recordings can then readily be reviewed by the one or more participants, the coaches, the team members, or family and friends of the one or more participants.

Embodiments solve the problem of needing to obtain and operate personal or professional recording equipment for recording and reviewing one's performance. They also address the problem of poor video angles recording through nets, glass, or obstructions common to sports facilities, performance halls, and other venues. For instance, embodiments help eliminate the chance of missing a specific location or time of the performance by using fixed and unmoving locations for the recording devices that cover the entire performance area within the recorded view. The unmoving location may also be a location that moves along a pre-set or preprogrammed track or path such as a moving camera mount known to those skilled in the art. Embodiments also help solve the problem of needing to copy the media so that the recording can be reviewed by many people at the same time. Several embodiments make the recorded video and audio readily available to anyone with a computer connected to the internet, even for people that are not located near the location where the recording was made.

The described embodiments are useful to any participant or team or persons that seek to improve their skills in an activity; sports such as ice hockey, basketball, volleyball, swimming, diving, baseball, soccer, football, rugby, and any team sport; physical activities like juggling, theatre, cheerleading, dancing, bowling, gymnastics, wrestling, and any physical activity; performance activities like speech-giving, presenting slides, and other activities where observing one's performance is likely to result in improving one's performance.

These embodiments can also be useful to any performer or sportsman. While recorded video and audio of professional sports or commercial performances may be readily available, these still rely on manual operation of the recording devices and they only help the professional sports team or commercial performer. Professional recordings are also focused mainly on entertainment, and not focused on allowing the performer to improve their skills. Current systems do not help amateurs review their own performance nor to improve their own skills.

The described embodiments involve the novel integration of several different technologies and devices. Although the prior art reflects many advances in recording, digital media, internet broadcasting, and sports techniques in their respective areas, none have not been coordinated or integrated in ways shown by the present inventive subject matter. As an example, security and surveillance systems record multiple video and audio of an area, but the purpose is to prevent theft and dangers. In another example, security and surveillance systems do not make the video and audio available to the people being recorded, and they do not help the people review their performance to improve their skills. Further, it is a very troublesome and manual process to remove video files from security and surveillance systems. Another example is taking pictures or videos with mobile phones or digital cameras and sharing these pictures and video and audio to friends and family on the internet. Internet sharing of pictures and videos requires manual operation of the recording equipment and does not provide multiple camera angles or unobstructed overhead views. While the videos and audio may be stored on the internet and accessible to others, it is not automatically uploaded from the performance area and does not help participants review their performance to improve their skills.

One embodiment includes a computer implemented method for improving an individual's skill at performing a physical activity including the steps of positioning one or more audio or visual or audio visual recording devices wherein the one or more devices have an unobstructed view of a performance area, recording video and/or audio of the one or more participants within the performance area over a period of time, processing the video and/or audio recordings and storing the recordings as a digital file format to one or more digital storage devices connected to a computer network. The one or more stored digital files can be played and viewed over the computer network so that the viewer can view and provide feedback to the one or more participants so that the one or more participants improve their skills based on that feedback.

Other embodiments include methods having recordings from two or more recording devices that are recorded simultaneously and synchronized, so that the individuals seeking to improve their skills can review the multiple recordings simultaneously and synchronously. Yet other embodiments include methods having recording devices that record automatically with no manual operation and the processing automatically moves with no manual operation the recordings and digital files to said storage devices. Another embodiment includes a method having a combination of recordings from the one or more recording devices which can provide a combined view of the entire performance area. Yet another embodiment includes a method where one or more of the recording devices records the entire performance area in a single view. Yet another embodiment includes a method having a playback interface that allows a user to view all the recording simultaneously or to view each and any of the recordings separately. Yet another embodiment includes a method having a playback interface that allows the user to create audio recordings and/or create markings, icons, or symbols representing the one or more participants in the performance area to instruct the one or more participants for improving their skills in performing various physical activities.

Another embodiment includes a computer implemented system for recording and improving the skill level of one or more persons being recorded. It includes one or more audio or visual or audio visual recording devices with each of the recording devices being positioned with unobstructed views of a performance area and wherein one or more recordings from said one or more recording devices are synchronized so that the recordings can be reviewed together and synchronously. This embodiment also includes one or more networked systems for transferring said digital recordings from the recording devices to one or more computers connected to a computer network such as the internet, and one or more browsers or electronic programs designed to play digital recordings over the network wherein the playback is used to analyze the performance taking place in the performance area.

Yet another embodiment includes the computer implemented system wherein the recording devices are positioned to record a sports field, sports court, other sports venue, performance area, stage, or other performance venue where a physical activity is performed. Yet another embodiment includes the computer implemented system wherein one or more recording devices are physically located above the performance area such that the recording provides an overhead view of the performance area. Yet another embodiment includes the computer implemented system wherein one or more of the recording devices has an unobstructed view of the performance area and is physically mounted in a fixed and unmoving location or physically mounted so the one or more devices can move within a predetermined range of locations.

Another embodiment of the computer implemented system further includes one or more audio visual recording devices that records a view of the entire performance area in a single view. Yet another embodiment includes a recording of the overhead view depicted on a screen or surface such that the individual participant can review their location and activities in the performance area. Yet another embodiment of the computer implemented system includes a screen or surface that is drawn with the same markings and boundaries in proportion to the sports field, court, surface, performance area, or other performance venue that depicted in the recordings. Another embodiment of the computer implemented system has the locations of the recorded individuals/participants compared to the locations of other individuals and/or participants in the performance area with the use of markings, icons, or symbols (some common symbols of which may be but are not limited to X, O, and arrows) to denote position and movement.

Another embodiment of the computer implemented system includes an electronic program displaying on the playback screen with surface markings, icons, or symbols representing the participants in the performance area and having the markings, icons, or symbols move across the playback screen or surface as the individual participants move across the video recording of the performance area. In yet another embodiment, a marker is included for marking digital recordings with the date, time, and a unique identifier such that electronic playback software can read these markings and play the one or more recordings simultaneously and synchronously. In another embodiment of the computer implemented system, a supplemental recording from a separate audio or visual or audio visual recording device that is simultaneously and synchronously played alongside the recordings of said system in the electronic playback software. In another embodiment of the computer implemented system, the electronic playback software further allows a user to create an additional audio recording that can be played synchronously to the video recordings so that the additional audio recording can be used to instruct one or more individual participants to improve their skill level or performance level.

### BRIEF DESCRIPTION OF THE DRAWINGS

FIG. 1 is an illustration of a device embodiment according to the claimed subject matter.

### DETAILED DESCRIPTION

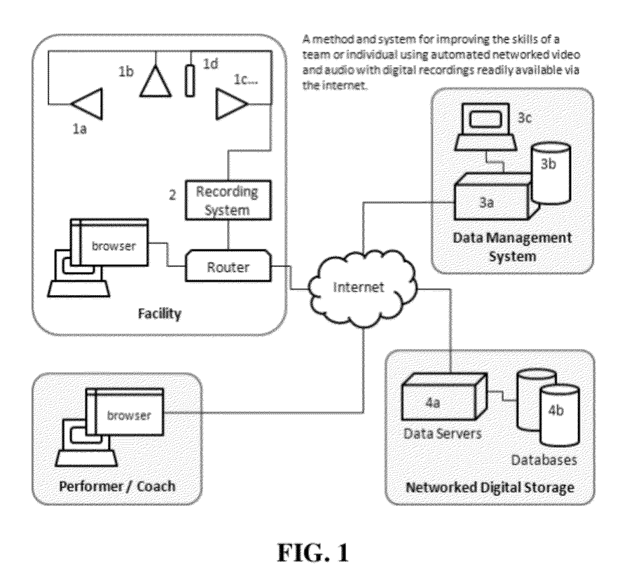

Referring first to FIG. 1, an illustration showing the elements of one embodiment.

In this embodiment, the numbered elements include:
1—one or more networked recording devices;
1a—a video recording device;
1b—a video recording device;
1c—additional video recording devices wherein one or more total video recording devices may be used;
1d—optional microphone (wherein one or more total microphones may be used if at all);
2—a digital recording system;
3—networked data management system;
3a—data server;
3b—one or more databases;
3c—computer terminal;
4—networked digital storage;
4a—one or more data servers; and
4b—one or more databases.

In this embodiment, the video and audio recording devices are installed at a performance area. The performance area could be a sports field, court, stage, performance area, or any other venue. The video and audio recording devices are networked devices and automatically transfer recordings to a networked system recorder located at the performance area.

The networked system recorder automatically transfers recordings to data servers and databases and networked digital storage systems connected to the internet. These types of systems are commonly referred to as “cloud” storage. The video and audio recordings can be reviewed by any computer connected to the internet using a standard internet browser and an electronic program designed to playback the recordings.

The claimed subject matter solves these problems by automating the video recording and audio recording and making the digital video and digital audio files available to the person or team seeking to improve their skills from a computer network such as the internet. Embodiments make the video and audio of the performance easily and readily available to the person, team, coach, parent, or counselor who is helping the person or team improve their skills. The embodiments also aid in the problem of the person or team using their own recording device and recording media and then transferring the video and audio to a different device for review. The same embodiments remove the hassle and inconvenience of finding friends or parents to manage the recording for the person or team seeking to improve their skills.

Embodiments of the claimed subject matter include a video and audio recording system installed or established at a facility. The facility may be a sports field, indoor sports playing court, gymnasium, ice rink, athletic complex, theatre stage, swimming pool or diving pool, bowling alley, golf course, dance floor, ski and snowboard course, cycling or running or driving course, court, stage, rink, pool, course, platform that a person, group or team would use to practice and improve their respective skills. The facility may also be more than one facilities used in combination as a single facility. The video and audio recording system will be comprised of one or more video recording devices whether digital or analog or other visual recording device, with zero or more audio microphones, whether digital or analog or other audio recording device. Any video recording device may include an audio recording device, and any audio recording device may include a video recording device. There will be at least one video recording made available through the embodiment.

The embodiments of the claimed subject matter can function with any type of digital file format for video and with any type of digital file format for audio. The video and audio from the video recording and audio recording devices will be converted into a digital format, such as any widely available and generally known digital video and digital audio file types. These file types may be a widely known digital file type or may be a proprietary digital file type. The digital video files and digital audio files will be stored either in the digital storage device or in another digital storage device which is connected to the video recording devices and audio recording devices by a network of computers and digital storage devices.

The embodiments may or may not include another digital device for temporarily storing the video and audio files from each of the video recording and audio recording devices. The invention can function both with and without this temporary storage device. In this case, the video recording devices and microphones will be connected to a digital system recorder. This system recorder may convert the analog video and audio into digital or the system recorder may accept digital video and digital audio or any combination of analog and digital video or audio. The system recorder and cameras and microphones may be a complete system, such as a surveillance and security camera system, or the system recorder and cameras and microphones may be a collection of standalone devices networked together and programmed to record video and audio and make the digital recording available to the internet.

The described embodiments include a network of computers and digital devices connected to the video recording devices and audio recording devices. Many of the embodiments function by recording the audio and video of the person or team seeking to improve their skills and making the digital video and audio files available to the person or team through a network of computers. The embodiments can also function using a network of computers in a closed system within the facility and using a network of computers in an open system across the internet.

Several of the embodiments use the internet to disseminate and distribute the recorded video and audio so that the recorded video and audio is widely and readily available to multiple interested persons. Interested persons may be the participants, the members of the team, the coach or director or team leader, friends and family members of the participants and team members, and other interested parties. Many of these embodiments use the internet so that multiple person(s) can view and review the recorded video and audio, overcoming the problems that exist with recording devices currently available to persons and teams seeking to improve their skills.

Many of these embodiments include a networked data management system that monitors the video and audio recordings and makes the digital recordings available on the internet to the participants, team members, and other interested parties. The data management system may or may not include data servers and digital data storage devices. The data management system may be physically located near or far from the video recording and audio recording devices. The use of the internet and one or more computer networks allows the embodiments to span geographic and physical proximity restrictions that exist with recording devices currently available to persons and teams seeking to improve their skills.

Embodiments can also include networked digital storage which itself can include digital data storage and one or more data servers that may or may not be part of the networked data management system. Networked data storage may also be separate from the networked data management system. Additionally, the networked data storage may be physically located near or far from the networked data management system.

Persons and teams seeking to improve their skills will access the embodiments through a physical computer that is running an electronic internet browser. The physical computer may be a personal or laptop computer, a tower or mainframe computer, a mobile phone, a digital video player, a digital audio player, a digital video and audio player, or any other computing device whose primary functions include interfacing with the internet through an electronic internet browser and playing video and audio.

These embodiments make available the recorded video and audio through an internet browser or electronic program designed to access and play the recorded video and audio. The persons and teams seeking to improve their skills can use the internet browser or electronic program to access a list of the recorded video and audio of interest to them, and then review the selected recorded video and audio through the internet browser or through a similar electronic program designed to access and play the recorded video and audio.

Although the foregoing embodiments of the inventive subject matter have been described in some detail by way of illustration and example for purposes of clarity and understanding, it will be apparent to those of ordinary skill in the art in light of the teaching of the inventive subject matter that certain changes and modifications may be made thereto without departing from the spirit or scope of the inventive subject matter including the appended claims.

1. A computer implemented method for improving an individual's skill at performing a physical activity comprising:
positioning one or more audio or visual or audio visual recording devices wherein said one or more devices have an unobstructed view of a performance area;
recording video and/or audio of said participants within said performance area over a period of time;
processing the video and/or audio recordings and storing said recordings as a digital file format to one or more digital storage devices connected to a computer network;
wherein said one or more stored digital files are played and viewed over said computer network so that the viewer can view and provide feedback to the individual so that the individual improves his or her skills based on said feedback.

2. The computer implemented method of claim 1 wherein said recordings from two or more recording devices are recorded simultaneously and synchronized, so that the individuals seeking to improve their skills can review the multiple recordings simultaneously and synchronously.

3. The computer implemented method of claim 2 wherein said recording devices record automatically with no manual operation and the processing automatically moves with no manual operation the recordings and digital files to said storage devices.

4. The computer implemented method of claim 3 wherein the combination of recordings from said one or more recording devices provide a combined view of the entire performance area.

5. The computer implemented method of claim 4 wherein one or more of the said recording devices records the entire performance area in a single view.

6. The computer implemented method of claim 5 wherein the playback interface allows the user to view all the recording simultaneously or to view each and any of the recordings separately.

7. The computer implemented method of claim 6 wherein the playback interface allows the user to create audio recordings and/or create markings, icons, or symbols representing said individuals in the performance area to instruct the individual to improve their skill at performing said physical activities.

8. A computer implemented system for recording and improving the skill level of one or more persons being recorded, the system comprised of:
a. one or more audio or visual or audio visual recording devices wherein each of said recording devices are located with unobstructed views of a performance area and wherein one or more recordings from said one or more recording devices are synchronized so that the recordings can be reviewed together and synchronously;
b. one or more networked systems for transferring said digital recordings from the recording devices to one or more computers connected to a computer network; and
c. one or more internet browsers or electronic programs designed to play digital recordings wherein said playback is used to analyze the performance taking place in the performance area.

9. The system of claim 8 wherein the recording devices are positioned to record a sports field, sports court, other sports venue, performance area, stage, or other performance venue where a physical activity is performed.

10. The system of claim 9 wherein one or more recording devices are physically located above the performance area such that the recording provides an overhead view of the performance area.

11. The system of claim 10 wherein one or more said recording devices has an unobstructed view of the performance area and is physically mounted in a fixed and unmoving location or physically mounted to move within a predetermined range of locations.

12. The system of claim 11 wherein one or more audio visual recording devices records a view of the entire performance area in a single view.

13. The system of claim 11 wherein the recording of the overhead view is depicted on a screen or surface such that the individual can review their location and activities in the performance area.

14. The system of claim 13 whereupon said screen or surface is drawn the same markings and boundaries in proportion to the sports field, court, surface, performance area, or other performance venue depicted in said recordings.

15. The system of claim 13 wherein the locations of the recorded individuals are compared to the locations of other individuals in the performance area with the use of markings, icons, or symbols (some common symbols of which may be but are not limited to X, O, and arrows) to denote position and movement.

16. The system of claim 15 wherein the electronic program displays on the playback screen or surface markings, icons, or symbols representing said individuals in the performance area and said markings, icons, or symbols move across the playback screen or surface as the individuals move across the video recording of the performance area.

17. The system of claim 11 further comprising a marker for marking digital recordings with the date, time, and a unique identifier such that electronic playback software can read these markings and play the one or more recordings simultaneously and synchronously.

18. The system of claim 11 further comprising a supplemental recording from a separate audio or visual or audio visual recording device that is simultaneously and synchronously played alongside the recordings of said system in the electronic playback software.

19. The system of claim 13 wherein the electronic playback software further allows a user to create an additional audio recording that is synchronous to the video recordings such that the additional audio recording instructs one or more individuals on improving their skill level or performance level.

20. The system of claim 8 wherein the computer network is the internet.
